(19) United States
(12) Patent Application Publication
(10) Pub. No.: US 2015/0271261 A1
(43) Pub. Date: Sep. 24, 2015

(54) SYSTEM AND METHOD FOR PROVIDING DISTRIBUTED VIRTUAL CLOUD USING MOBILE GRID

(71) Applicant: Korea Advanced Institute of Science and Technology, Daejeon (KR)

(72) Inventors: Hong Shik Park, Daejeon (KR); Jun Seop Ahn, Daejeon (KR); Jae Won Ahn, Daejeon (KR)

(73) Assignee: Korea Advanced Institute of Science and Technology, Daejeon (KR)

(21) Appl. No.: 14/503,006

(22) Filed: Sep. 30, 2014

(30) Foreign Application Priority Data
Mar. 21, 2014 (KR) 10-2014-0033207
May 28, 2014 (KR) 10-2014-0064592

(51) Int. Cl. H04L 29/08

(52) U.S. Cl. CPC H04L 67/1044

(57) ABSTRACT

A system and method for providing a distributed virtual cloud by using a mobile grid are disclosed. The system for providing a distributed virtual cloud according to an exemplary embodiment of the present invention may include a social topology creating unit creating a social topology based upon social relationships between user equipments configuring a Social Network Service (SNS), a cluster configuration unit configuring a social topology cluster based upon closeness centrality between the user equipments configuring the Social Network Service (SNS), and a cloud interoperation unit performing interoperation between a virtual cloud corresponding to each social topology cluster and a cloud managing the social topology.

This application claims the benefit of the Korean Patent Application Nos. 10-2014-0033207, filed on Mar. 21, 2014, and 10-2014-0064592, filed on May 28, 2014, which are hereby incorporated by reference as if fully set forth herein.

### BACKGROUND OF THE INVENTION

1. Field of the Invention

The exemplary embodiments of the present invention relate to a system and method for providing a distributed virtual cloud that can effectively accommodate a Social Network Service(SNS) by using relationships between a user and his (or her) friends.

2. Discussion of the Related Art

With the evolution and development of the Internet and smart phones, sharing of information through Social Network Service (SNS) is increasing. As described above, as an increased amount of information is being shared through the SNS, the types of information that is being shared are also becoming more diverse.

For example, in addition to merely delivering (or conveying) a user's opinion, thoughts, experiences, and so on via text, information is being shared in more extended formats, such as audio, video, images, and so on. Accordingly, an amount of the data (or data size) being processed by the SNS is increased, thereby causing a word load in a server that manages the Social Network Service (SNS).

Therefore, a technology that can reduce the work load of the server managing the SNS is being required.

### SUMMARY OF THE INVENTION

Accordingly, the present invention is directed to a system and method for providing a distributed virtual cloud by using a mobile grid that substantially obviate one or more problems due to limitations and disadvantages of the related art.

An object of the present invention is to provide a system and method for providing a distributed virtual cloud by using a mobile grid that can reduce work load of a server managing a Social Network Service (SNS), by configuring the virtual cloud using a grid resource of a user equipment, so that multiple user equipments configuring the Social Network Service (SNS) can be managed by distributed management.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for providing a distributed virtual cloud according to an exemplary embodiment of the present invention may include a social topology creating unit creating a social topology based upon social relationships between user equipments configuring a Social Network Service (SNS), a cluster configuration unit configuring a social topology cluster based upon closeness centrality between the user equipments configuring the Social Network Service (SNS), and a cloud interoperation unit performing interoperation between a virtual cloud corresponding to each social topology cluster and a cloud managing the social topology.

According to an aspect of the present invention, the cluster configuration unit may decide a main user equipment from the user equipments configuring the Social Network Service (SNS), and the cluster configuration unit may configure a social topology cluster, the social topology cluster consisting of user equipments that are selected based upon distances between the main user equipment and each of the user equipments.

According to another aspect of the present invention the virtual cloud may provide a Point-to-Point (P2P) function in accordance with a request made by a user equipment that belongs to the social topology cluster.

According to yet another aspect of the present invention, the cloud may migrate data and resources to the virtual cloud, the data and resources being used for managing user equipments that belong to the social topology cluster.

According to a further aspect of the present invention, the virtual cloud may exist in a base station or access point (AP) to which the social topology cluster belongs.

A method for providing a distributed virtual cloud according to an exemplary embodiment of the present invention may include the steps of creating a social topology based upon social relationships between user equipments configuring a Social Network Service (SNS), configuring a social topology cluster based upon closeness centrality between the user equipments configuring the Social Network Service (SNS), and performing interoperation between a virtual cloud corresponding to each social topology cluster and a cloud managing the social topology.

According to an aspect of the present invention, the step of configuring a social topology cluster may include the steps of deciding a main user equipment from the user equipments configuring the Social Network Service (SNS), and configuring a social topology cluster, the social topology cluster consisting of user equipments that are selected based upon distances between the main user equipment and each of the user equipments.

According to another aspect of the present invention, the virtual cloud may provide a Point-to-Point (P2P) function in accordance with a request made by a user equipment that belongs to the social topology cluster.

According to yet another aspect of the present invention, the cloud may migrate data and resources to the virtual cloud, the data and resources being used for managing user equipments that belong to the social topology cluster.

According to a further aspect of the present invention, the virtual cloud may exist in a base station or access point (AP) to which the social topology cluster belongs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an overall configuration of a system for providing a distributed virtual cloud according to an exemplary embodiment of the present invention;

FIG. 2 illustrates an exemplary view showing operations for configuring a social topology cluster according to an exemplary embodiment of the present invention;

FIG. 3 illustrates a structure of a system for providing a distributed virtual cloud according to an exemplary embodiment of the present invention;

FIG. 4 illustrates a flow chart showing process steps of a method for providing a distributed virtual cloud according to an exemplary embodiment of the present invention;

FIG. 5 illustrates a flow chart providing a more detailed description of a method for configuring a social topology cluster according to an exemplary embodiment of the present invention; and

FIG. 6 illustrates a block view showing an internal configuration of a system for providing a distributed virtual cloud according to an exemplary embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

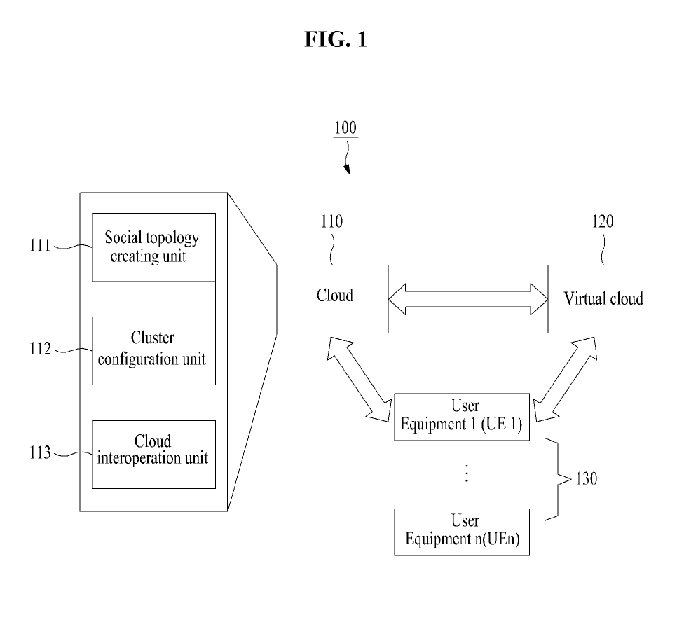

FIG. 1 illustrates an overall configuration of a system for providing a distributed virtual cloud according to an exemplary embodiment of the present invention.

Referring to FIG. 1, a system for providing a distributed virtual cloud (or distributed virtual cloud providing system) 100 may include a cloud 110, a virtual cloud 120, and multiple user equipments (UEs) 130. Herein, a user equipment may correspond to devices that can be carried (or held) by users, such as Smart Phones, Web Books, i-Pads, and so on.

Additionally, the cloud 110 may include a social topology creating unit 111, a cluster configuration unit 112, and a cloud interoperation unit 113. For example, the cloud 110 may correspond to a server that manages user equipments configuring the Social Network Service (SNS).

The social topology creating unit 111 may create a social topology based upon friendship (or social relationship) between the user equipments configuring the Social Network Service (SNS).

The cluster configuration unit 112 may decide a main UE based upon a closeness centrality between the user equipments configuring the Social Network Service (SNS), and, then, the cluster configuration unit 112 may configure a social topology cluster by using the relationship between the main UE and each of the UEs configuring the Social Network Service (SNS).

Herein, a social topology cluster is configured to distribute traffic of the network while reducing the load being concentrated in the network, and the social topology cluster may indicate that a social topology has been divided into multiple clusters.

The cloud interoperation unit 113 may interoperate with the virtual cloud 120, which manages the social topology cluster.

One virtual cloud 120 exists for each social topology cluster, and the virtual cloud 120 may correspond to a server existing within a base station or Access Point (AP) respective to a social topology cluster. As described above, as the virtual cloud 120 performs the function of a server, when user equipments belonging to the social topology cluster communicate with one another, the data may be processed by the virtual cloud 120 without having to pass through the cloud 110. Accordingly, the load of the cloud 110 may be reduced, and the network resource may be efficiently used.

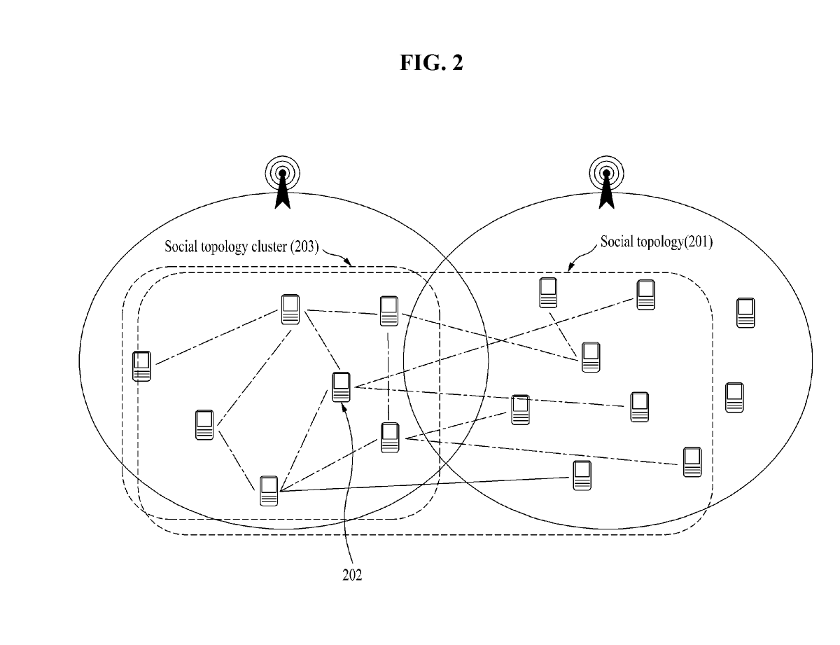

FIG. 2 illustrates an exemplary view showing operations for configuring a social topology cluster according to an exemplary embodiment of the present invention.

Referring to FIG. 2, the social topology creating unit 111 may create a social topology 201 based upon social relationships between the user equipments configuring the social network service.

Accordingly, the cluster configuration unit 112 may decide (or determine) a main user equipment among the multiple user equipments belonging to the social topology. At this point, the cluster configuration unit 112 may decide the main user equipment based upon a closeness centrality between the user equipment belonging to the social topology.

For example, the cluster configuration unit 112 may decide a user equipment having a highest closeness centrality as the main user equipment among the multiple user equipments belonging to the social topology 201 based upon Equation 1 shown below.

[Equation 1]

C_{c}(i)=[Σᵢ₌₁^{N}d(i, j)]⁻¹ (1)

In Equation 1, C_{c} represents a maximum (or highest) closeness centrality of user equipment i, and d(i,j) may indicate a distance between user equipment i and user equipment j.

For example, according to Equation 1, among the multiple user equipments belonging to the social topology 201, the cluster configuration unit 112 may decide a user equipment having a minimum (or smallest) sum of minimum distances (or shortest distances) between the corresponding user equipment and other user equipment belonging to the social topology 201 as the main user equipment. In other words, the cluster configuration unit 112 may decide a user equipment having a minimum sum of actual distances between the corresponding user equipment and other user equipments as the main user equipment 202.

Accordingly, the cluster configuration unit 112 may configure a social topology cluster 203 based upon the closeness centrality of between the main user equipment 202 and each of the other user equipments.

For example, the cluster configuration unit 112 may configure a social topology cluster 203 consisting of user equipments each having a closeness centrality that is equal to or greater than a predetermined reference value k with respect to the main user equipment 202. In other words, the cluster configuration unit 112 may configure a social topology cluster 203 consisting of user equipments within close range with the main user equipment 202 among the user equipments belonging to the social topology 201.

At this point, the social topology cluster 203 may be configured of user equipments within a wireless base station or access point (AP) in accordance with the configuration of the reference value k, and the social topology cluster 203 may also be configured throughout multiple base stations or multiple access points (AP). In case the social topology cluster is configured throughout multiple base stations or multiple access points (AP), a virtual cloud of the social topology cluster 203 may be positioned in the main user equipment, which has the maximum closeness centrality. In other words, a server and storage managing the virtual cloud may exist in a main user equipment belonging to the social topology cluster 203.

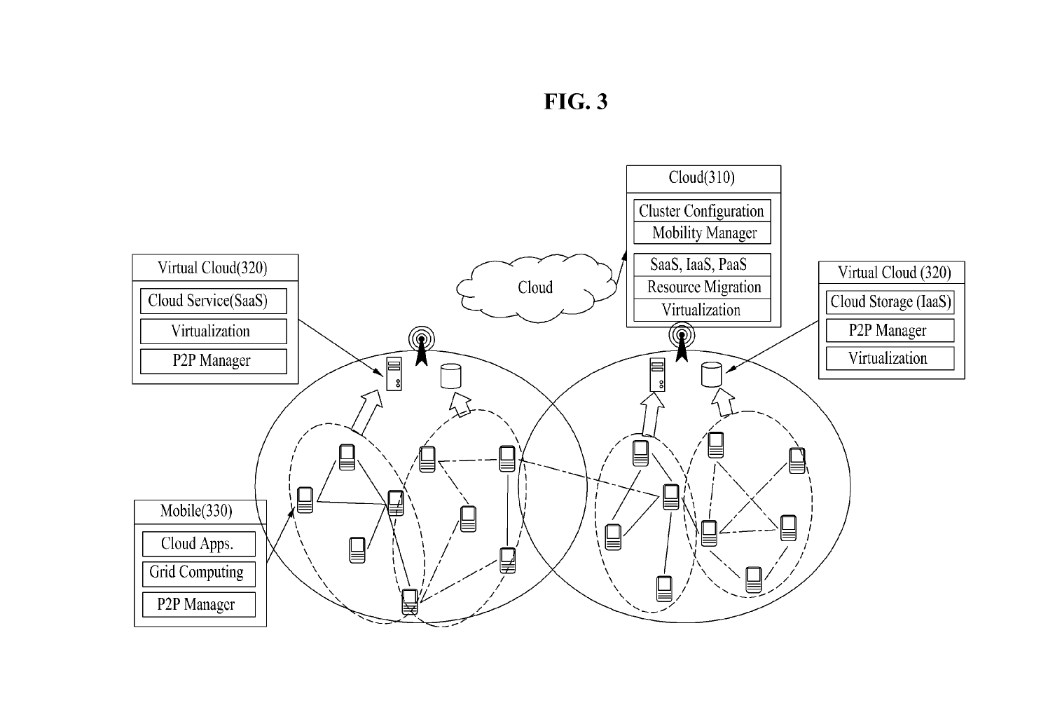

FIG. 3 illustrates a structure of a system for providing a distributed virtual cloud according to an exemplary embodiment of the present invention.

A user of a cloud-based social network service may access the service through a cellular or wireless LAN network by using a wireless user equipment. At this point, a server and storage for configuring and managing a virtual cloud may exist in a wireless AP or wireless base station.

As a cloud configuring the social network service, the cloud 310 may manage mobility information of a user equipment 330 and may configure a social topology cluster. Additionally, the cloud 310 may decide and configure a virtual cloud for each social topology cluster, and, then, the cloud 310 may interoperate with the configured virtual cloud. In order to do so, the cloud 310 may include a cluster configuration unit, a mobility manager, a resource migration unit, and a virtualization unit.

Herein, the mobility manager may corresponds to the social topology creating unit 111 of FIG. 1, and the cluster configuration unit and the resource migration unit may collectively correspond to the cluster configuration unit 112 of FIG. 1, and the virtualization unit may correspond to the cloud interoperation unit 113 of FIG. 1.

First of all, the mobility manager may manage mobility information of user equipments, wherein the mobility information is used for calculating the closeness centrality of each of the user equipments configuring the social network service.

Accordingly, the cluster configuration unit may calculate the closeness centrality between each user equipment and may configure a social topology cluster based upon the calculated closeness centrality.

As the social topology cluster is configured, since a virtual cloud 320 requires the data and resources that are stored in the cloud 310, the resource migration unit may migrate the corresponding data and resources to the virtual cloud 320.

The virtualization unit may perform a virtualization process between the cloud 310 and the virtual cloud 320.

The virtual cloud 320 may be configured in accordance with the virtualization of a grid resource of a user equipment and a cloud server within the base station based upon the social topology cluster, which is configured in the cloud 310.

Additionally, the virtual cloud 320 may periodically receive reports on a presence or absence of idle resources, which are required when configuring a virtual cloud, from the user equipment 330. The virtual cloud 320 may deliver content to the virtual cloud in accordance with a request for content within the social topology cluster, and the virtual cloud 320 may also support Point-to-Point (P2P) functions to the user equipments belonging to the social topology cluster.

In order to do so, the virtual cloud 320 may include a Cloud Service (Software as a Service (SaaS)), a Cloud Storage (Interface as a Service (IaaS)), a Virtualization unit, a Grid Computing unit, and a P2P manager.

The cloud service may provide a virtual cloud based social network service. And, the Cloud Storage may store content and may perform the role of a cache server. The virtualization unit may virtualize a server in order to manage grid resources of the user equipment and the social topology cluster. The grid computing unit may periodically receive reports on idle resources from the user equipment and may request the user equipment for grid resources whenever required. The P2P manager may manage data transmission so that, depending upon the content type, data can be transmitted to and from user equipments via P2P transmission without passing through the Cloud Storage.

For example, as a user equipment belonging to the social topology cluster request for P2P function support, the P2P manager of the virtual cloud may provide the P2P function to the user equipment that has made the respective request. As described above, as the virtual cloud provides a function enabling data transmission to be performed via P2P transmission between user equipments belonging to the social topology cluster, instead of receiving content from the cloud or the virtual cloud, the user equipment 330 may directly receive content from a user equipment, wherein the requested content is stored, by using the supported P2P function.

The user equipment 330 may include Cloud Applications, a Grid Computing unit, and a P2P manager.

The user equipment 330 may configure a social network service by installing a cloud application, which is provided by the cloud 310.

The grid computing unit may allocate (or assign) grid resources to the virtual cloud 320 in accordance with the request of work distribution and resources made by the virtual cloud.

Instead of receiving content from the cloud 310 or the virtual cloud 320 in accordance with the type of the content, which is request from the user equipment, the P2P manager may receive content from a user equipment, to which the virtual cloud 320 has granted the requested P2P function, via P2P transmission.

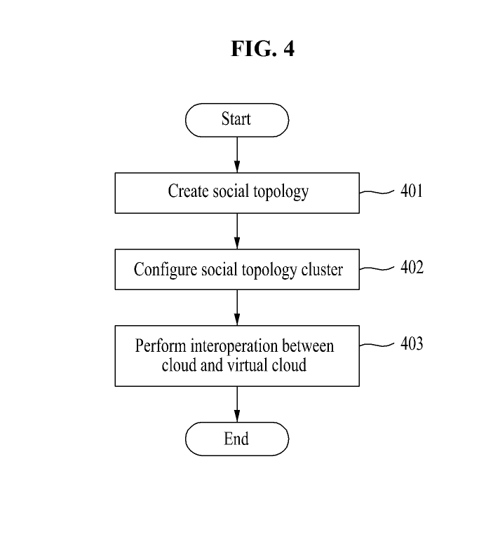

FIG. 4 illustrates a flow chart showing process steps of a method for providing a distributed virtual cloud according to an exemplary embodiment of the present invention.

In FIG. 4, the method for providing a virtual distributed cloud may be performed by the system for providing a virtual distributed cloud, which is shown in FIG. 2 and FIG. 3.

In step S401, the cloud may generate a social topology based upon social relationships between each of the user equipments that configure the social network service.

And, in step S402, the cloud may configure a social topology cluster based upon closeness centrality between each of the user equipments configuring the social network service.

For example, the cloud may decide a user equipment having a highest closeness centrality as the main user equipment among the multiple user equipments configuring the social network service. And, the cloud may calculate closeness centrality between each of the user equipments configuring the social network service and the decided main user equipment. At this point, the cloud may a select user equipment having a calculated closeness centrality that is equal to or greater than a predetermined reference value as the user equipment belonging to the social topology cluster. Subsequently, the cloud may configure a social topology cluster including the selected user equipment and the main user equipment. As described above, in order to reduce the load being concentrated to the corresponding cloud, the cloud may divide the social topology into multiple social topology clusters, and, then, the cloud may manage the social topology clusters by using a virtual cloud respective to each of the social topology clusters.

Thereafter, in step S403, the cloud may perform interoperation with the virtual cloud, which manages the respective social topology cluster.

For example, as a social topology cluster is being configured, the cloud may migrate data and resources to the virtual cloud in order to establish interoperation with the virtual cloud, which manages the respective social topology cluster. As described above, after the migration of data, the cloud may interoperate with the virtual cloud by virtualizing the virtual cloud.

Accordingly, the virtual cloud may provide a P2P function in accordance with the request made by the user equipment, which belongs to the social topology cluster. Herein, the virtual cloud may exist in a base station or access Point (AP) to which the social topology belongs.

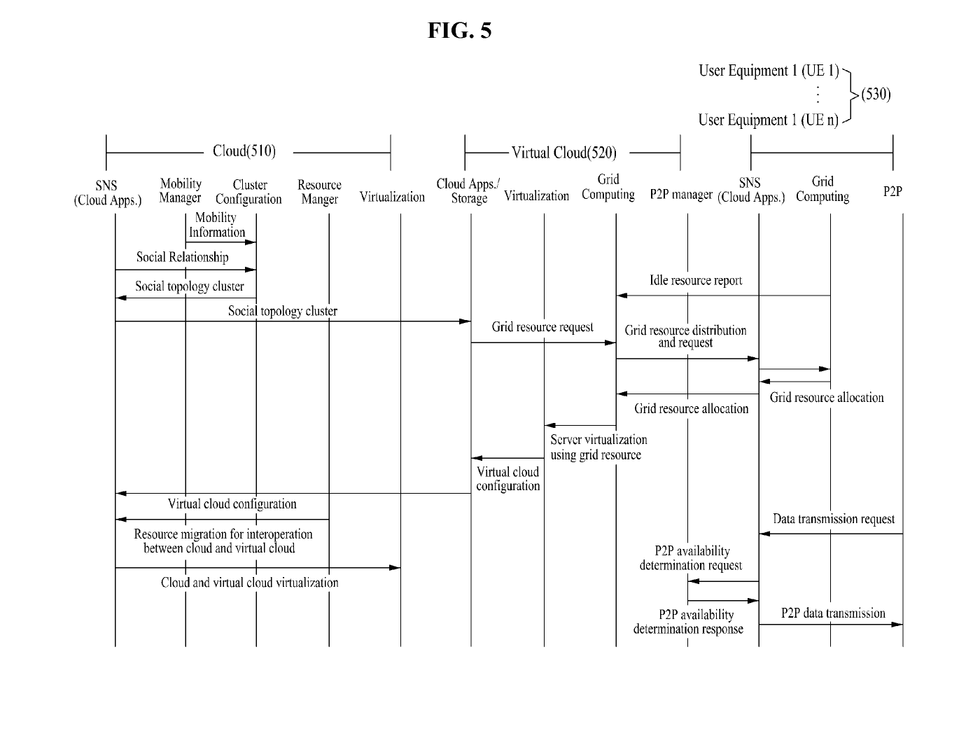

FIG. 5 illustrates a flow chart providing a more detailed description of a method for configuring a social topology cluster according to an exemplary embodiment of the present invention.

Referring to FIG. 5, the cloud 510 may provide Cloud Applications to a user equipment, which has requested for the configuration of a Social Network Service (SNS). Accordingly, when the social network service is configured, the cloud 510 may manage the social relationship between each of the user equipments configuring the social network service, and, then, the cloud 510 may manage mobility information of user equipments, wherein the mobility information is used for calculating the closeness centrality of each of the user equipments configuring the social network service. At this point, the cloud 510 may periodically receive reports from the user equipments 530 on the presence or absence of idle resources, which are required for configuring the virtual cloud.

For example, the cloud 510 calculates the closeness centrality between the user equipments by using the idle resources of the user equipment 530, and, then, the cloud 510 may configure the social topology cluster based upon the calculated closeness topology.

Accordingly, the virtual cloud 520, which manages the social topology cluster, may request the user equipments 530, which collectively configure the social topology cluster, for grid resources in order to distribute work. As a response to the request for the grid resources, the user equipments 530 may allocate the grid resources to the virtual cloud 520.

Subsequently, the virtual cloud 520 may perform virtualization process, which establishes interoperation between the cloud 510 and the virtual cloud 520, by using the allocated grid resources. For example, a server that exists in a base station or access point (AP) corresponding to the social topology cluster may be virtualized. Accordingly, the virtualized server may be capable of managing the social topology cluster.

The virtual cloud 520 may notify the cloud 510 that a virtual cluster has been configured within the social topology cluster, and, then, the virtual cloud 520 may request the cloud 510 to migrate data and resources, which are required for managing the social topology cluster. Accordingly, the cloud 510 may migrate the data and resources, which have been requested by the virtual cloud 520, to the virtual cloud 520. As the data and resources are migrated, as described above, the virtualization process between the cloud 510 and the virtual cloud 520 may be completed. In other words, interoperation may be established between the cloud 510 and the virtual cloud 520.

At this point, data transmission may be requested by at least one of the user equipments configuring the social topology cluster. For example, user equipment 1 (UE 1) may request the virtual cloud 520 to perform data transmission. At this point, UE 1 may request the virtual cloud 520 to verify whether or not data can be transmitted via P2P transmission. Accordingly, the virtual cloud 520 may transmit a message, which indicates whether or not P2P transmission can be performed in accordance with the type of the request data, to UE 1.

For example, in case the virtual cloud 520 sends a response message to UE 1 indicating that the P2P transmission can be performed, UE 1 may receive data via P2P transmission from a user equipment storing the requested data, among the multiple user equipments configuring the social topology cluster.

Additionally, in case the virtual cloud 520 sends a response message to UE 1 indicating that the P2P transmission cannot be performed, UE 1 may receive data from a user equipment storing the requested data from the virtual cloud 520 or the cloud 510.

As described above, instead of having work processes requested by the user equipments configuring the social topology cluster concentratedly processed by the cloud 510, by configuring multiple social topology clusters, the work processes requested by the user equipments may be distributedly processed by each virtual cloud.

Finally, by providing the P2P function to the user equipments in accordance with the respective data type, the virtual cloud 520 may efficiently manage network resources.

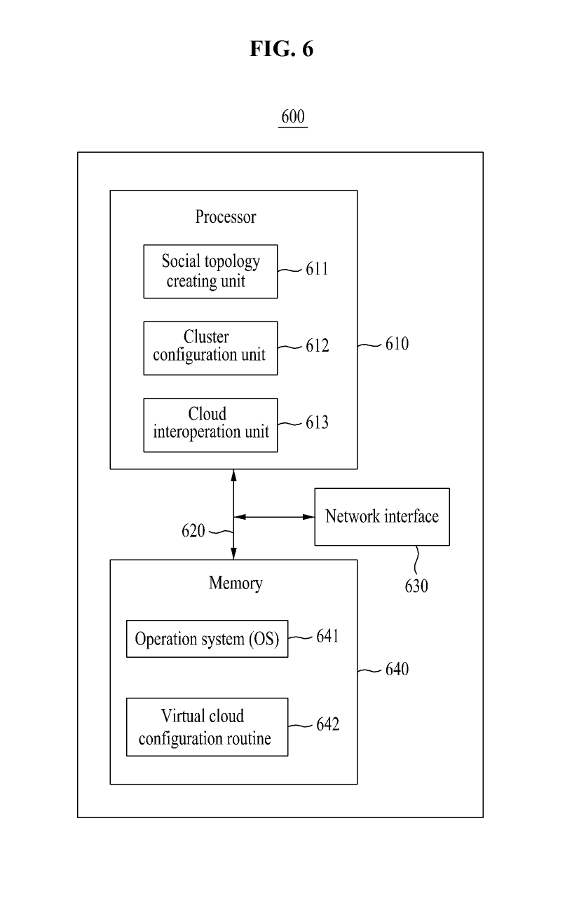

FIG. 6 illustrates a block view showing an internal configuration of a system for providing a distributed virtual cloud according to an exemplary embodiment of the present invention.

The system for providing a distributed virtual cloud (or distributed virtual cloud providing system) 600 according to an exemplary embodiment of the present invention may include a processor 610, a bus 620, a network interface 630, and a memory 640. The memory 640 may include an operation system (OS) 641 and a virtual cloud configuration routine 642. For example, a program code for the operation system (OS) 641 and the virtual cloud configuration routine 642 may be stored in the memory 640. Accordingly, the processor 610 may execute a virtual cloud configuration routine, which is stored in the memory 640 and may, then, configure a social topology cluster and a virtual cloud.

The processor 610 may include a social topology creating unit 611, a cluster configuration unit 612, and a cloud interoperation unit 613. Herein, since the operations of the social topology creating unit 611, the cluster configuration unit 612, and the cloud interoperation unit 613 have already been described above with reference to FIG. 1, detailed description of the same will be omitted for simplicity.

The memory 640 corresponds to a computer-readable recording medium, which may include random access memory (RAM), read-only memory (ROM), and permanent mass storage devices, such as disk drives. Additionally, a program code for the operation system (OS) 641 and the virtual cloud configuration routine 642 may be stored in the memory 640. Such software components may be loaded from the computer-readable recording medium other than the memory 640 by using a drive mechanism (not shown). Examples of such separate computer-readable recording media (not shown) may include a floppy disk drive, a disk, a tape, DVD/CR-ROM drives, memory cards, and so on. According to another exemplary embodiment of the present invention, the software component may also be loaded to the memory 640 through the network interface 630 instead of a computer-readable recording medium.

The bus 620 allows communication and data transmission to be performed between the components of the distributed virtual cloud providing system 600. The bus 620 may be configured by using a high-speed serial bus, a parallel bus, a Storage Area Network (SAN), and/or other adequate communication technologies.

The network interface 630 may correspond to a computer hardware component, which is used for connecting the distributed virtual cloud providing system 600 to a computer network through a wired or wireless connection.

By performing basic calculation, logic, and input/output operations (or calculations) of the distributed virtual cloud providing system 600, the processor 610 may be configured to process commands made by computer programs. A command may be provided to the processor 610 by the memory 640 or the network interface 630 and through the bus 620. The processor 610 may be configured to execute program codes, which are configured for the social topology creating unit 611, the cluster configuration unit 612, and the cloud interoperation unit 613. Such program codes may be stored in a recording device, such as the memory 640.

As described above, the system and method for providing a distributed virtual cloud by using a mobile grid have the following advantages. According to the present invention, by configuring a virtual cloud by using a grid resource of a user equipment, user equipments configuring a Social Network Service (SNS) may be managed by distributed management, and a work load of a server managing the Social Network Service (SNS) may be reduced.

The method according to the exemplary embodiment of the present invention may be realized in a program command (or instruction) format that may be executed by using diverse computing means, so as to be recorded in a computer-readable medium. Herein, the computer-readable medium may independently include a program command (or instruction), a data file, a data structure, and so on, or may include a combination of the same. The program command being recorded in the medium may correspond to a program command that is specifically designed and configured for the exemplary embodiments of the present invention, or the program command may correspond to a program command that is disclosed and available to anyone skilled in or related to computer software. Examples of the computer-readable recording medium may include magnetic media, such as hard discs, floppy discs, and magnetic tapes, optical media, such as CD-ROMs, DVDs, and so on, magneto-optical media, such as floptical discs, and hardware devices specially configured (or designed) for storing and executing program commands, such as ROMs, RAMs, flash memories, and so on. Examples of a program command may not only include machine language codes, which are created by a compiler, but may also include high-level language codes, which may be executed by a computer by using an interpreter, and so on. The above-mentioned hardware equipment may be configured to be operated as one or more software modules for executing the operations of the exemplary embodiment of the present invention, and vice versa.

It will be apparent to those skilled in the art that various modifications and variations can be made in the present invention without departing from the spirit or scope of the inventions. For example, the above-described techniques may be executed in an order different from that described in the description of the present invention, and/or the components of the above-described system, structure, equipment (or device), circuit, and so on, may be combined in a format different that of the above-described method according to the present invention, and an adequate result may be achieved even if the above-described components of the present invention are replaced by any other component or its equivalent.

Thus, it is intended that the present invention covers other realizations and other embodiments of this invention provided they come within the scope of the appended claims and their equivalents.

What is claimed is:

1. A system for providing a distributed virtual cloud, comprising:
a social topology creating unit creating a social topology based upon social relationships between user equipments configuring a Social Network Service (SNS);
a cluster configuration unit configuring a social topology cluster based upon closeness centrality between the user equipments configuring the Social Network Service (SNS); and
a cloud interoperation unit performing interoperation between a virtual cloud corresponding to each social topology cluster and a cloud managing the social topology.

2. The system of claim 1, wherein the cluster configuration unit decides a main user equipment from the user equipments configuring the Social Network Service (SNS), and wherein the cluster configuration unit configures a social topology cluster, the social topology cluster consisting of user equipments that are selected based upon distances between the main user equipment and each of the user equipments.

3. The system of claim 1, wherein the virtual cloud provides a Point-to-Point (P2P) function in accordance with a request made by a user equipment that belongs to the social topology cluster.

4. The system of claim 1, wherein the cloud migrates data and resources to the virtual cloud, the data and resources being used for managing user equipments that belong to the social topology cluster.

5. The system of claim 1, wherein the virtual cloud exists in a base station or access point (AP) to which the social topology cluster belongs.

6. A method for providing a distributed virtual cloud, comprising:
creating a social topology based upon social relationships between user equipments configuring a Social Network Service (SNS);
configuring a social topology cluster based upon closeness centrality between the user equipments configuring the Social Network Service (SNS); and
performing interoperation between a virtual cloud corresponding to each social topology cluster and a cloud managing the social topology.

7. The method of claim 6, wherein the configuring a social topology cluster comprises:
deciding a main user equipment from the user equipments configuring the Social Network Service (SNS); and
configuring a social topology cluster, the social topology cluster consisting of user equipments that are selected based upon distances between the main user equipment and each of the user equipments.

8. The method of claim 6, wherein the virtual cloud provides a Point-to-Point (P2P) function in accordance with a request made by a user equipment that belongs to the social topology cluster.

9. The method of claim 6, wherein the cloud migrates data and resources to the virtual cloud, the data and resources being used for managing user equipments that belong to the social topology cluster.

10. The method of claim 6, wherein the virtual cloud exists in a base station or access point (AP) to which the social topology cluster belongs.
